(19) United States
(12) Patent Application Publication
(10) Pub. No.: US 2005/0059748 A1
(43) Pub. Date: Mar. 17, 2005

(54) Aqueous emulsion polymerization process for preparing voided polymer particles

(76) Inventor: Robert Mitchell Blankenship, Harleysville, PA (US)

Correspondence Address: ROHM AND HAAS COMPANY;PATENT DEPARTMENT, 100 INDEPENDENCE MALL WEST, PHILADELPHIA, PA, 19106-2399, US

(21) Appl. No.: 10/939,657

(22) Filed: Sep. 13, 2004

Related U.S. Application Data
(60) Provisional application No. 60/503,212, filed on Sep. 15, 2003.

(51) Int. Cl. C08J 9/00

(52) U.S. Cl. 521/50

(57) ABSTRACT

A process is provided for preparing voided polymer particles. The process includes the emulsion polymerization of multistage polymer particles in a first vessel and the preparation of the voided polymer particles from the multistage polymer particles in a second vessel. Also provided is an aqueous dispersion of voided polymer particles prepared by this process.

This invention generally relates to a process for preparing voided polymer particles. In particular, the present invention relates to an aqueous emulsion polymerization process for preparing voided polymer particles and to aqueous dispersions containing the voided polymer particles formed therefrom.

Aqueous dispersions containing hollow or voided polymer particles, are known for use in several industrial applications. The literature uses the terms “hollow” and “voided” interchangeably. These polymer particles are often used in paints, coatings, inks, sunscreens, and paper manufacture. Voided polymer particles are generally prepared by swelling core-shell polymer particles in such a way that one or more voids form in the interior of the polymer particles. These voids contribute, among other things, to the opacity of coatings and films that are prepared with the voided polymer particles. For some applications, it is particularly desirable to minimize the weight of the coating applied. For example, it is desirable for certain paper coatings applications to have a high performance coating without adding considerably to the weight of the paper.

Voided polymer particles can be prepared by any of several known process, including those described U.S. Pat. Nos. 4,427,836, 4,468,498, 4,594,363, 4,880,842, 5,494,971, 5,521,253, 5,157,084, 5,360,827, 6,252,004 among others. Voided polymer particles, as described in the references noted above, are prepared by swelling the cores of core-shell polymer particles. In the disclosure of U.S. Pat. No. 6,252,004, an aqueous emulsion process is described in which an effective amount of polymerization inhibitor or reducing agent is added to substantially stop any polymerization in the latter stages of polymerizing the shells. In this process, monomer is then added to facilitate diffusion of base into the cores of the polymer particles in order to achieve swelling of the core-shell polymer particles to form the voided polymer particles.

In the production of voided polymer particles, the productivity of a reactor is typically limited by the volume solids of the voided polymer particles, and not by the weight solids of the voided polymer particles. The step of preparing the core-shell polymer particles utilizes less than the full volume capacity of the reactor, as space must be provided in the reactor for the excess water required during the subsequent step of swelling the core-shell polymer particles. During the step of swelling the core-shell polymer particles, water is drawn into the internal voids of the voided polymer particles. Excess water is also required to provide sufficient volume to form the continuous phase of the resulting aqueous dispersion containing the voided polymer particles. Typically, the production yield of the voided polymer particles is limited by the volume capacity of the reaction vessel. Processes are desired that provide increased throughput of the voided polymer particles from a reaction vessel, on a volume basis, thus increasing the capacity utilization of the reaction vessel.

The inventor has discovered a process for increasing the capacity utilization of a reaction vessel to prepare voided polymer particles. In the present invention, a process is provided that employs two or more vessels to prepare an aqueous dispersion of voided polymer particles. The process includes the steps of preparing multistage polymer particles in a reaction vessel and swelling of these multistage polymer particles in a second vessel to provide the voided polymer particles. The separation of these two steps into different vessels allows for increased capacity utilization of the reaction vessel.

According to the first aspect of the present invention, a process is provided for preparing an aqueous dispersion of voided polymer particles, including:
a) preparing an aqueous dispersion of multistage polymer particles in a first vessel; wherein the multistage polymer particles contain: i) a core stage polymer containing as polymerized units, based on weight of the core stage polymer: from 5 to 100 weight % hydrophilic monoethylenically unsaturated monomer, and from 0 to 95 weight % of at least one nonionic monoethylenically unsaturated monomer; ii) a shell stage polymer containing as polymerized units, based on weight of the multistage polymer particles, at least 50 weight % of at least one nonionic monoethylenically unsaturated monomer;
b) providing monomer at a level of at least 0.5 weight % based on weight of the multistage polymer particles under conditions wherein there is no substantial polymerization of the monomer;
c) swelling the multistage polymer particles in a second vessel; and then
d) reducing the level of the monomer by at least 50 weight % of the monomer, to provide the aqueous dispersion of voided polymer particles.

The second aspect of the present invention provides an aqueous dispersion containing voided polymer particles; wherein the aqueous dispersion is prepared according to a process including the steps of:
a) preparing an aqueous dispersion of multistage polymer particles in a first vessel; wherein the multistage polymer particles contain: i) a core stage polymer containing as polymerized units, based on weight of the core stage polymer: from 5 to 100 weight % hydrophilic monoethylenically unsaturated monomer, and from 0 to 95 weight % of at least one nonionic monoethylenically unsaturated monomer; ii) a shell stage polymer containing as polymerized units, based on weight of the multistage polymer particles, at least 50 weight % of at least one nonionic monoethylenically unsaturated monomer;
b) providing monomer at a level of at least 0.5 weight % based on weight of the multistage polymer particles under conditions wherein there is no substantial polymerization of the monomer;
c) swelling the multistage polymer particles in a second vessel; and then
d) reducing the level of the monomer by at least 50 weight % of the monomer, to provide the aqueous dispersion of voided polymer particles.

As used herein, the use of the term “(meth)” followed by another term such as acrylate refers to both acrylates and methacrylates. For example, the term “(meth)acrylate” refers to either acrylate or methacrylate; the term “(meth)acrylic” refers to either acrylic or methacrylic; the term “(meth)acrylonitrile” refers to either acrylonitrile or methacrylonitrile; and the term “(meth)acrylamide” refers to either acrylamide or methacrylamide.

As used herein, the term “dispersion” refers to a physical state of matter that includes at least two distinct phases, wherein a first phase is distributed in a second phase, with the second phase being a continuous medium. The term “aqueous dispersion” refers to a dispersion having a continuous medium that is predominately water.

The process of the present invention employs two or more vessels to prepare an aqueous dispersion of voided polymer particles. The process includes preparing an aqueous dispersion of multi-stage polymer particles in a reaction vessel, referred to herein as first vessel” and then swelling the multi-stage polymer particles in a second vessel. The separation of these two steps into separate vessels allows the polymerization of a greater quantity of the multi-stage polymer particles in the reaction vessel. Since the excess water required for the step of swelling the multi-stage polymer particles may be added to the second vessel and not to the reaction vessel, the aqueous dispersion containing the multi-stage polymer particles may be prepared at a high level of solids or utilizing a greater capacity of the volume of the reaction vessel.

The multi-stage polymer particles have a core stage polymer (the “core”), and shell stage polymer (the “shell”). The core and shell may themselves include more than one stage. There may also be one or more intermediate stages. Preferably, the multi-stage polymer has a core, an intermediate layer, and a shell.

The cores of the multi-stage polymers are emulsion polymers containing, as polymerized units, from 5 to 100 percent by weight, based on the weight of the core, of at least one hydrophilic monoethylenically unsaturated monomer and from 0 to 95 percent by weight, based on the weight of the core stage polymer, of at least one nonionic monoethylenically unsaturated monomer.

Cores containing at least five percent by weight, based on the total weight of the core polymer, of at least one hydrophilic monoethylenically unsaturated monomer will generally result in a suitable degree of swelling. There may be instances wherein, because of the hydrophobicity of certain comonomers or combinations thereof in conjunction with the hydrophobic/hydrophilic balance of a particular hydrophilic monomer, the copolymer may be suitably prepared with less than five percent by weight, based on the total weight of the core polymer, of a hydrophilic monoethylenically unsaturated monomer. Preferably, the core contains, as polymerized units, hydrophilic monoethylenically unsaturated monomer at a level of from 5 to 100, more preferably, from 20 to 60, and most preferably, from 30 to 50 percent by weight based on the total weight of the core. The hydrophilic core polymer may be made in a single stage or step of the sequential polymerization or may be made by a plurality of steps in sequence.

The multi-stage emulsion polymer has a core polymer wherein at least one hydrophilic monoethylenically unsaturated monomer is polymerized alone or with at least one nonionic monoethylenically unsaturated monomer. This process also contemplates, and includes in the term “hydrophilic monoethylenically unsaturated monomer,” the use of a nonpolymeric compound containing at least one carboxylic acid group which absorbed into the core polymer before, during or after the polymerization of the hydrophobic shell polymer as a replacement for the hydrophilic monoethylenically unsaturated monomer in the hydrophilic core polymer, as described in U.S. Pat. No. 4,880,842. In addition, this invention contemplates, and includes in the term “hydrophilic monoethylenically unsaturated monomer,” the use of a latent hydrophilic core polymer which contains no hydrophilic monoethylenically unsaturated monomer but which is swellable upon hydrolysis to a hydrophilic core polymer as described in U.S. Pat. No. 5,157,084.

Suitable hydrophilic monoethylenically unsaturated monomer useful for making the core polymer include monoethylenically unsaturated monomers containing acid-functionality such as monomers containing at least one carboxylic acid group including acrylic acid, methacrylic acid, acryloxypropionic acid, (meth)acryloxypropionic acid, itaconic acid, aconitic acid, maleic acid or anhydride, fumaric acid, crotonic acid, monomethyl maleate, monomethyl fumarate, monomethyl itaconate and the like. Acrylic acid and methacrylic acid are preferred.

Suitable nonpolymeric compounds containing at least one carboxylic acid group include C₆-C₁₂ aliphatic or aromatic monocarboxylic acids and dicarboxylic acids, such as benzoic acid, m-toluic acid, p-chlorobenzoic acid, o-acetoxybenzoic acid, azelaic acid, sebacic acid, octanoic acid, cyclohexanecarboxylic acid, lauric acid and monobutyl phthalate and the like.

Suitable nonionic monoethylenically unsaturated monomers for making the hydrophilic core polymer include styrene, a-methyl styrene, p-methyl styrene, t-butyl styrene, vinyltoluene, ethylene, vinyl acetate, vinyl chloride, vinylidene chloride, (meth)acrylonitrile, (meth)acrylamide, (C₁-C₂₀)alkyl or (C₃-C₂₀)alkenyl esters of (meth)acrylic acid, such as methyl(meth)acrylate, ethyl(meth)acrylate, butyl(meth)acrylate, 2-ethylhexyl(meth)acrylate, hydroxyethyl(meth)acrylate, hydroxypropyl(meth)acrylate, benzyl(meth)acrylate, lauryl(meth)acrylate, oleyl(meth)acrylate, palmityl(meth)acrylate, stearyl(meth)acrylate and the like.

The core, whether obtained by a single stage process or a process involving several stages, has an average particle diameter of from 50 nanometer (nm) to 1.0 micron, preferably from 100 nm to 500 nm, diameter in unswollen condition. If the core is obtained from a seed polymer, the seed polymer preferably has an average particle diameter of from 30 nm to 200 nm.

The core may also optionally contain less than 20 percent by weight, preferably from 0.1 to 3 percent by weight, based on the total weight of the core, of polyethylenically unsaturated monomer, wherein the amount used is generally approximately directly proportional to the amount of hydrophilic monoethylenically unsaturated monomer used; in other words, as the relative amount of hydrophilic monomer increases, it is acceptable to increase the level of polyethylenically unsaturated monomer. Alternatively, the core polymer may contain from 0.1 to 60 percent by weight, based on the total weight of the core polymer, of butadiene.

Suitable polyethylenically unsaturated monomers include comonomers containing at least two addition polymerizable vinylidene groups and are alpha beta ethylenically unsaturated monocarboxylic acid esters of polyhydric alcohols containing 2-6 ester groups. Such comonomers include alkylene glycol diacrylates and dimethacrylates, such as for example, ethylene glycol diacrylate, ethylene glycol dimethacrylate, 1,3-butylene glycol diacrylate, 1,4-butylene glycol diacrylate propylene glycol diacrylate and triethylene glycol dimethylacrylate; 1,3-glycerol dimethacrylate; 1,1,1-trimethylol propane dimethacrylate: 1,1,1-trimethylol ethane diacrylate; pentaerythritol trimethacrylate; 1,2,6-hexane triacrylate; sorbitol pentamethacrylate; methylene bis-acrylamide, methylene bis-methacrylamide, divinyl benzene, vinyl methacrylate, vinyl crotonate, vinyl acrylate, vinyl acetylene, trivinyl benzene, triallyl cyanurate, divinyl acetylene, divinyl ethane, divinyl sulfide, divinyl ether, divinyl sulfone, diallyl cyanamide, ethylene glycol divinyl ether, diallyl phthalate, divinyl dimethyl silane, glycerol trivinyl ether, divinyl adipate; dicyclopentenyl (meth)acrylates; dicyclopentenyloxy (meth)acrylates; unsaturated esters of glycol monodicyclopentenyl ethers; allyl esters of α,β-unsaturated mono- and dicarboxylic acids having terminal ethylenic unsaturation including allyl methacrylate, allyl acrylate, diallyl maleate, diallyl fumarate, diallyl itaconate and the like.

The multi-stage polymer of the present invention preferably contains an intermediate stage. The intermediate stage polymer, when present, partially or fully encapsulates the core and itself is partially or fully encapsulated by the shell. The intermediate stage is prepared by conducting an emulsion polymerization in the presence of the core.

The intermediate stage preferably contains, as polymerized units, from 0.3 to 20, more preferably from 0.5 to 10 percent by weight, based on the weight of the intermediate stage, of at least one hydrophilic monoethylenically unsaturated monomer. The intermediate stage preferably contains, as polymerized units, from 80 to 99.7, more preferably from 90 to 99.5 percent by weight, based on the weight of the intermediate stage, of at least one nonionic monoethylenically unsaturated monomer. The hydrophilic monoethylenically unsaturated monomers and the nonionic monoethylenically unsaturated monomers useful for making the core are also useful for making the intermediate layer. The intermediate layer may contain from 0 to 2 percent by weight, based on the weight of the intermediate stage, of at least one polyethylenically unsaturated monomer.

The shell of the multi-staged polymer is the product of emulsion polymerizing from 80 to 100, preferably from 90 to 100, percent by weight, based on the total weight of the shell, of at least one nonionic monoethylenically unsaturated monomer. The nonionic monoethylenically unsaturated monomers suitable for the core are also suitable for the shell. Styrene is preferred.

The shell may also contain, as polymerized units, from 0 to 20, preferably from 0 to 10, percent by weight based on the weight of the shell, of one or more monoethylenically unsaturated monomers containing acid-functionality for making the hydrophobic polymer shell include acrylic acid, methacrylic acid, acryloxypropionic acid, (meth)acryloxypropionic acid, itaconic acid, aconitic acid, maleic acid, maleic anhydride, fumaric acid, crotonic acid, monomethyl maleate, monomethyl fumarate, monomethyl itaconate and the like. Acrylic acid and methacrylic acid are preferred.

The monomers used and the relative proportions thereof in the shell should be such that it is permeable to an aqueous or gaseous volatile or fixed basic swelling agent capable of swelling the core. Monomeric mixtures for making the shell preferably contain from about 0.1% by weight to about 10% by weight, based on the total weight of the shell polymer, of an acid-functional monoethylenically unsaturated monomer. Preferably, the proportion of acid-functional monoethylenically unsaturated monomer in the shell polymer does not exceed one-third the proportion thereof in the core polymer.

As used herein, the term “sequentially emulsion polymerized” or “sequentially emulsion produced” refers to polymers (including homopolymers and copolymers) which are prepared in aqueous medium by an emulsion polymerization process in the presence of the dispersed polymer particles of a previously formed emulsion polymer such that the previously formed emulsion polymers are increased in size by deposition thereon of emulsion polymerized product of one or more successive monomer charges introduced into the medium containing the dispersed particles of the preformed emulsion polymer.

In the sequential emulsion polymerization with which the present invention is concerned, the term “seed” polymer is used to refer to an aqueous emulsion polymer dispersion which may be the initially-formed dispersion, that is, the product of a single stage of emulsion polymerization or it may be the emulsion polymer dispersion obtained at the end of any subsequent stage except the final stage of the sequential polymerization. Thus, a hydrophilic core polymer which is herein intended to be encapsulated by one or more subsequent stages of emulsion polymerization may itself be termed a seed polymer for the next stage.

The method of this invention contemplates that the core, the intermediate stage, the shell, or any combination thereof may be made in a single stage or step of the sequential polymerization or may be made by a plurality of steps in sequence following the polymerization. The first stage of emulsion polymerization in the process of the present invention may be the preparation of a seed polymer containing small dispersed polymer particles insoluble in the aqueous emulsion polymerization medium. This seed polymer may or may not contain any hydrophilic monomer component but provides particles of minute size which form the nuclei on which the hydrophilic core polymer, with or without nonionic comonomer, is formed.

A water-soluble free radical initiator is utilized in the aqueous emulsion polymerization. Suitable water-soluble free radical initiators include hydrogen peroxide; tert-butyl peroxide; alkali metal persulfates such as sodium, potassium and lithium persulfate; ammonium persulfate; and mixtures of such initiators with a reducing agent. Reducing agents include: sulfites, such as alkali metal metabisulfite, hydrosulfite, and hyposulfite: sodium formaldehyde sulfoxylate; and reducing sugars such as ascorbic acid and isoascorbic acid. The amount of initiator is preferably from 0.01 to 3 percent by weight, based on the total amount of monomer and in a redox system the amount of reducing agent is preferably from 0.01 to 3 percent by weight based on the total amount of monomer. The temperature may be in the range of about 10° C. to 100° C. In the case of the persulfate systems, the temperature is preferably in the range of 60° C. to 90° C. In the redox system, the temperature is preferably in the range of 30° C. to 70° C., preferably below about 70° C., more preferably in the range of 30° C. to 60° C. The type and amount of initiator may be the same or different in the various stages of the multi-stage polymerization.

One or more nonionic or anionic emulsifiers, or surfactants, may be used, either alone or together. Examples of suitable nonionic emulsifiers include tert-octylphenoxyethylpoly(39)-ethoxyethanol, dodecyloxypoly(10)ethoxyethanol, nonylphenoxyethyl-poly(40)ethoxyethanol, polyethylene glycol 2000 monooleate, ethoxylated castor oil, fluorinated alkyl esters and alkoxylates, polyoxyethylene (20) sorbitan monolaurate, sucrose monococoate, hydroxyethylcellulosepolybutyl acrylate graft copolymer, di(2-butyl)phenoxypoly(20)ethoxyethanol, dimethyl silicone polyalkylene oxide graft copolymer, poly(ethylene oxide)poly(butyl acrylate) block copolymer, block copolymers of propylene oxide and ethylene oxide, 2,4,7,9-tetramethyl-5-decyne-4,7-diol ethoxylated with 30 moles of ethylene oxide, N-polyoxyethylene(20)lauramide, N-lauryl-N-polyoxyethylene(3)amine and poly(10)ethylene glycol dodecyl thioether. Examples of suitable anionic emulsifiers include sodium lauryl sulfate, sodium dodecylbenzenesulfonate, potassium stearate, sodium dioctyl sulfosuccinate, sodium dodecyldiphenyloxide disulfonate, nonylphenoxyethylpoly(1)ethoxyethyl sulfate ammonium salt, sodium styrene sulfonate, sodium dodecyl allyl sulfosuccinate, linseed oil fatty acid, sodium or ammonium salts of phosphate esters of ethoxylated nonylphenol, sodium octoxynol-3-sulfonate, sodium cocoyl sarcocinate, sodium 1-alkoxy-2-hydroxypropyl sulfonate, sodium alpha-olefin (C₁₄-C₁₆)sulfonate, sulfates of hydroxyalkanols, tetrasodium N-(1,2-dicarboxy ethyl)-N-octadecylsulfosuccinamate, disodium N-octadecylsulfosuccinamate, disodium alkylamido polyethoxy sulfosuccinate, disodium ethoxylated nonylphenol half ester of sulfosuccinic acid and the sodium salt of tert-octylphenoxyethoxypoly(39)ethoxyethyl sulfate. The one or more surfactants are generally used at a level of from 0 to 3 percent based on the weight of the multi-stage polymer. The one or more surfactants can be added prior to the addition of any monomer charge, during the addition of a monomer charge or a combination thereof. In certain monomer/emulsifier systems for forming the shell, the tendency to produce gum or coagulum in the reaction medium may be reduced or prevented by the addition of about 0.05% to about 2.0% by weight, based on total weight of the shell polymer, of emulsifier without detriment to the deposition of the polymer formed on the previously formed core particles.

The amount of emulsifier may be zero, in the situation wherein a persulfate initiator is used, to 3 percent by weight, based on the weight of total weight of the core polymer. By carrying out the emulsion polymerization while maintaining low levels of emulsifier, the subsequent stages of polymer-formation deposit the most-recently formed polymer on the existing dispersed polymer particles resulting from the preceding step or stage. As a general rule, the amount of emulsifier should be kept below that corresponding to the critical micelle concentration for a particular monomer system, but while this limitation is preferable and produces a unimodal product, it has been found that in some systems the critical micelle concentration of the emulsifier may be exceeded somewhat without the formation of an objectionable or excessive number of dispersed micelles or particles. It is for the purpose of controlling the number of micelles during the various stages of polymerization so that the deposition of the subsequently formed polymer in each stage occurs upon the dispersed micelles or particles formed in the previous stages, that the concentration of emulsifier is kept low.

The viscosity-average molecular weight of the polymer formed in a given stage may range from 100,000, or lower if a chain transfer agent is used, to several million molecular weight. When 0.1% by weight to 20% by weight, based on the weight of the monomer, of a polyethylenically unsaturated monomer mentioned hereinbefore is used in making the core, the molecular weight is increased whether or not crosslinking occurs. The use of the polyethylenically unsaturated monomer reduces the tendency of the core polymer to dissolve when the multistage polymer is treated with a swellant for the core. If it is desired to produce a core having a molecular weight in the lower part of the range, such as from 500,000 down to as low as about 20,000, it is frequently most practical to do so by avoiding the polyethylenically unsaturated monomers and using a chain transfer agent instead, such as 0.05% to 2% or more thereof, examples being alkyl mercaptans, such as sec-butyl mercaptan.

The weight ratio of core to the intermediate stage, if present, is generally in the range of from 1:0.5 to 1:10, preferably in the range of from 1:1 to 1:7. The weight ratio of core to shell is generally in the range of from 1:5 to 1:20, preferably in the range of from 1:8 to 1:15. When trying to decrease the dry density of the final product, is preferred to have as little shell as possible while still encapsulating the core.

The amount of polymer deposited to form shell polymer is generally such as to provide an overall size of the multistage polymer particle of from 70 nm to 4.5 microns, preferably from 100 nm to 3.5 microns, more preferably from 200 nm to 2.0 microns, in unswollen condition (that is, before any neutralization to raise the pH to about 6 or higher) whether the shell polymer is formed in a single stage or in a plurality of stages. In order to minimize the dry density of the final product, it is preferable to deposit only as much shell polymer as is needed to fully encapsulate the core. When the hydrophilic core polymer is fully encapsulated, it does not titrate with alkali metal bases under normal analytical conditions of about 1 hour and at room temperature. The extent of encapsulation can be determined by removing samples during the course of the shell polymerization and titrating with sodium hydroxide.

The multi-stage emulsion polymer is prepared by sequential emulsion polymerization, which, as discussed above, includes charging the monomers which form the shell. At, or near, the conclusion of charging the monomers which form the shell, the contents of the reactor include the multistage polymer, water and unreacted monomer. Under the conditions of an emulsion polymerization, there is also an appreciable free-radical content, or radical flux, which keeps the polymerization process going. Even if no additional monomer or initiator is added, there is an appreciable free-radical content in the system. When there is no appreciable free-radical content, in other words, when the radical flux is very low or approaches zero, then no substantial amount of polymerization will occur.

The process of this invention includes the step of providing monomer at a level of at least 0.5 weight % based on weight of the multistage polymer particles under conditions wherein there is no substantial polymerization of the monomer. There are many means for providing that no substantial polymerization of monomer is occurring, including the addition of one or more polymerization inhibitors, the addition of one or more reducing agents, waiting for a sufficient period of time until there are no longer an appreciable number of free-radicals by virtue of them terminating, cooling the contents of the reactor to limit the reactivity of the free-radicals, and combinations thereof. In one embodiment, the process of this invention includes a step of adding an effective amount of one or more polymerization inhibitors of reducing agents to substantially stop any polymerization. In another embodiment, the process involves the addition of one or more polymerization inhibitors such as, for example, N,N-diethylhydroxylamine, N-nitrosodiphenylamine, 2,4-dinitrophenylhydrazine, p-phenylenediamine, phenathiazine, alloocimene, triethyl phosphite, 4-nitrosophenol, 2-nitrophenol, p-aminophenol, 4-hydroxy-TEMPO (also known as 4-hydroxy-2,2,6,6, tetramethylpiperidinyloxy, free radical), hydroquinone, p-methoxyhydroquinone, tert-butyl-p-hydroquinone, 2,5-di-tert-butyl-p-hydroquinone, 1,4-naphthalenediol, 4-tert butyl catechol, copper sulfate, copper nitrate, cresol and phenol to substantially stop any polymerization. When used, the polymerization inhibitors or reducing agents are added in effective amount to substantially stop any polymerization, generally from 25 to 5,000 parts per million (“ppm”), preferably from 50 to 3,500 ppm based on polymer solids. The polymerization inhibitor(s) or reducing agent(s) may be added while the multistage polymer is at or below the temperature at which the shell was polymerized, most preferably within ten degrees Celsius below the temperature at which the shell was polymerized.

In step of providing monomer at a level of at least 0.5 weight % based on weight of the multistage polymer particles, the monomer is present at, or after providing that no substantial polymerization of monomer is occurring. This monomer may be (i) one or more of the monomers used to prepare any of the stages of the multistage polymer, (ii) one or more monomers other than those use to prepare any of the stages of the multistage polymer, or (iii) combinations thereof Preferably, monomer present at such time is one or more of the monomers used to prepare the shell. Such monomer may be unreacted monomer from preparing the multi-stage emulsion polymer, it may be separately added, or a combination thereof. Preferably, the monomer is nonionic monomer. Nonionic monomer is preferred because acid-functional monomers will be neutralized by the swelling agent, and these neutralized monomers are difficult to remove by polymerization. Preferably the level of monomer present at, or after providing that no substantial polymerization of monomer is occurring is from 1 to 20 times as much as the standing monomer level during polymerization.

The process of this invention includes the step of adding one or more swelling agents to the multistage polymer particles to form the voided polymer particles. The swelling agent is added to the multistage polymer particles in the second vessel. One or more swelling agents are used. Suitable swelling agents include, are those which, in the presence of the multistage emulsion polymer and monomer, are capable of permeating the shell and swelling the core. Swelling agents may be aqueous or gaseous, volatile or fixed bases or combinations thereof. Suitable swelling agents include volatile bases such as ammonia, ammonium hydroxide, sodium hydroxide, potassium hydroxide, and volatile lower aliphatic amines, such as morpholine, trimethylamine, and triethylamine, and the like; fixed or permanent bases such as potassium hydroxide, lithium hydroxide, zinc ammonium complex, copper ammonium complex, silver ammonium complex, strontium hydroxide, barium hydroxide and the like. Solvents, such as, for example, ethanol, hexanol, octanol, 2,2,4-trimethyl-1,3-pentanediol monoisobutyrate, and those described in U.S. Pat. No. 4,594,363, may be added to aid in fixed or permanent base penetration. Ammonia and ammonium hydroxide are preferred.

When trying to maximize the extent of swelling, it is preferable that the one or more swelling agents are added after providing that no substantial polymerization of monomer is occurring. The amount of swelling agent can be less than, equal to or greater than the amount needed to provide for complete neutralization of the core. Preferably, the amount of swelling agent is in the range of from 75 to 300 percent, more preferably in the range of from 90 to 250 percent based on the equivalents of the functionality in the core capable of being neutralized. It is also preferable to add the one or more swelling agents to the multistage emulsion polymer while the multistage emulsion polymer is at an elevated temperature, preferably at a temperature within 10° C. of the shell polymerization temperature. Swelling is generally very efficient under conditions of elevated temperature, in the presence of monomer and no substantial polymerization occurring. Under these conditions, swelling is generally complete within 30 minutes, preferably within 20 minutes, most preferably within 15 minutes of adding the one or more swelling agents.

The core polymer of the multistage emulsion polymer swells when the core is subjected to a basic swelling agent that permeates the shell to at least partially neutralize the hydrophilic-functionality of the core, preferably to a pH of at least about 6 to at least about 10, and thereby result in swelling by hydration of the hydrophilic core polymer. The swelling, or expansion, of the core may involve partial merging of the outer periphery of the core into the pores of the inner periphery of the shell and also partial enlargement or bulging of the shell and the entire particle overall.

In the process of the present invention, water may be added to the second vessel to provide sufficient water for swelling the multistage polymer particles to form the voided polymer particles. The water may be added prior to or during the swelling step. Although some or all of the water needed to swell the multistage polymer particles may be included in the first vessel, the volume capacity of the first vessel, in which the multistage polymer particles are polymerized, may be increased by minimizing the addition of the extra water required for the swelling of the multistage polymer particles, thus maximizing the weight solids of the aqueous dispersion of the multistage polymer particles in the first vessel. Preferably, some or all of the water required for swelling the multistage polymer particles is added to the second vessel. Examples of the amount of water that is required for swelling the multistage polymer particles to provide the aqueous dispersion of voided polymer particles is in the range of from 10 to 125%, preferably in the range of from 20 to 100%, and more preferably in the range of from 30 to 70% of the volume of the aqueous dispersion of the multistage polymer particles prepared in the first vessel.

The weight % solids of the aqueous dispersion of the multistage polymer particles in the first vessel may be at least 35 weight %, preferably at least 40 weight %, and more preferably at least 45 weight %, based on the weight of the aqueous dispersion of the multistage polymer particles.

When the swollen multistage emulsion polymer is dried, water and/or swelling agent are removed from the central region of the swollen multistage emulsion polymer, the core tends to shrink and a void develops, the extent of which depends upon the resistance of the shell to restoration to its previous size. This resistance of the shell restoring itself to its previous size is critical for minimizing the dry bulk density of the swollen multistage emulsion polymer. The expansion of the core results in expansion of the shell also. As the size of the shell is restored to its previous size, the dry bulk density increases. It is desirable, therefore, to minimize the extent to which the size of the shell is restored, thereby maximizing the dry bulk density of the swollen multistage emulsion polymer.

This can be accomplished by reducing the monomer level. It is believed that the presence of monomer is helpful in facilitating the swelling of the multistage polymer, whether by plasticizing the shell, aiding in the transport through the shell or a combination thereof. However, the presence of monomer is detrimental when trying to maximize swelling and minimize the dry bulk density of the swollen multistage emulsion polymer. Accordingly, after swelling the multistage emulsion polymer in the presence of both monomer and swelling agent, it is desirable to reduce the level of monomer to less than 10,000 ppm, preferably to less than 5,000 ppm based on polymer solids. This can be accomplished by any suitable means. Preferably, the level of monomer is reduced by polymerizing the monomer. This can be accomplished by any suitable means, such as by adding one or more initiators such as those recited above. It is preferred to begin to reduce the level of monomer within 20 minutes, more preferably within 10 minutes, of adding the one or more swelling agents.

The process of this invention employs at least two vessels. Generally, in large scale production, the first vessel is a reactor, which is equipped with a mixing device, temperature control equipment, inlet lines, and an outlet. Suitable mixing devices include four blade agitators and 45 degree pitched turbine agitators. Examples of temperature control equipment include jacketed reactors and external circulation heat exchanger. Typically, the first vessel has several inlet lines for the co-addition of monomers, initiator, and other synthesis adjuvants. The inlet lines are commonly equipped with valves to regulate flow rates and flow meters to measure the rate of flow. In large scale production, the second vessel is typically a processing tank, a holding tank, or a storage tank. The second vessel may be equipped with a mixing device. Generally, the second vessel has a larger volume than the first vessel. Further, generally the second vessel has a lower pressure rating than the first vessel. In one embodiment, the volume of the second vessel is at least 1.2 times greater, preferably at least 1.5 times greater, and more preferably at least 2 times greater, than the volume of the first vessel. In another embodiment, the heat exchanger plates included in the heat exchanger are assembled using single gaskets. The use of single gaskets, instead of double gaskets between the process and utility sections of the heat exchange plates, reduces or eliminates the air pocket created between the process and utility sections of the heat exchange plates. Any weep holes in the gaskets are plugged. The single gaskets may be prepared by modifying existing double gaskets or molding single gaskets.

The excess water for the step of swelling the multistage polymer particles may be added to either the first vessel, the second vessel, or both. Preferably the excess water is added to the second vessel prior to, during, or after the addition of the aqueous dispersion containing the multistage polymer particles to the second vessel.

More than one second vessel may be employed in the process of this invention. For example, the process may be practiced in a system including a reactor with two connected drain tanks. In this system, the aqueous dispersion of multistage polymer particles is prepared in the reactor (first vessel). Next, a portion of the contents of the first vessel is transferred to one of the drain tanks and the remaining portion of the contents of the first vessel is transferred to the other drain tank. The swelling agent is added to each of the drain tanks to prepare the aqueous dispersion of voided polymer particles.

In one embodiment of the process of this invention, the aqueous dispersion of voided polymer particles are prepared according to the steps of: preparing an aqueous dispersion of multistage polymer particles in a first vessel; adding an effective amount of one or more polymerization inhibitors or reducing agents to the first vessel to substantially stop any polymerization; providing monomer in the first vessel at a level of at least 0.5 weight % based on weight of the multistage polymer particles; transferring at least a portion of the aqueous dispersion of multistage polymer particles to a second vessel; adding swelling agent to the multistage polymer particles in the second vessel; and reducing the level of the monomer by at least 50 weight % of the monomer, to provide the aqueous dispersion of voided polymer particles.

In a different embodiment of the process of this invention, the aqueous dispersion of voided polymer particles are prepared according to the steps of: preparing an aqueous dispersion of multistage polymer particles in a first vessel; adding an effective amount of one or more polymerization inhibitors or reducing agents to the first vessel to substantially stop any polymerization; transferring at least a portion of the aqueous dispersion of multistage polymer particles to a second vessel; providing monomer in the second vessel at a level of at least 0.5 weight % based on weight of the multistage polymer particles; adding swelling agent to the multistage polymer particles in the second vessel; and reducing the level of the monomer by at least 50 weight % of the monomer, to provide the aqueous dispersion of voided polymer particles.

In a still different embodiment of the process of this invention, the aqueous dispersion of voided polymer particles are prepared according to the steps of: preparing an aqueous dispersion of multistage polymer particles in a first vessel; transferring at least a portion of the aqueous dispersion of multistage polymer particles to a second vessel; adding an effective amount of one or more polymerization inhibitors or reducing agents to the second vessel to substantially stop any polymerization; providing monomer in the second vessel at a level of at least 0.5 weight % based on weight of the multistage polymer particles; adding swelling agent to the multistage polymer particles in the second vessel; and reducing the level of the monomer by at least 50 weight % of the monomer, to provide the aqueous dispersion of voided polymer particles.

In an alternative embodiment, the second vessel is a continuous or semi-continuous vessel. Examples of continuous vessels include flow tube reactors or heat exchangers. In semi-continuous vessels, the aqueous dispersion containing the multistage polymer particles is flowed into the second vessel with the co-addition of the one or more swelling agents; the contents of the second vessel reside in the second vessel for an average time, referred to as the “residence time”, and the aqueous dispersion containing voided polymer particles is removed from the second vessel. Generally, in a semi-continuous process, steady state flow conditions are employed wherein the average total flow rate of aqueous dispersion containing the multistage polymer particles and other materials into the second vessel is the same as the average flow rate of the aqueous dispersion containing the voided polymer particles exiting from the second vessel.

The process of the present invention is capable of producing swollen multi-stage polymers having very low bulk density. Swollen multi-stage polymers having an a particle size below 275 nm can be prepared with a dry bulk density of from 0.30 to 0.77 g/cc (grams per cubic centimeter), preferably from 0.35 to 0.76 g/cc, most preferably from 0.40 to 0.75 g/cc. Swollen multi-stage polymers having an a particle size in the range of from 275 to 500 nm can be prepared with a dry bulk density of from 0.30 to 0.74 g/cc, preferably from 0.35 to 0.73 g/cc, most preferably from 0.40 to 0.72 g/cc. Swollen multi-stage polymers having an a particle size in the range of from 501 to 750 nm can be prepared with a dry bulk density of from 0.30 to 0.59 g/cc, preferably from 0.35 to 0.58 g/cc, most preferably from 0.40 to 0.57 g/cc. Swollen multi-stage polymers having an a particle size in the range of from 751 to 1,300 nm can be prepared with a dry bulk density of from 0.30 to 0.46 g/cc, preferably from 0.35 to 0.45 g/cc, most preferably from 0.40 to 0.44 g/cc.

The voided latex particles produced by the method of the present invention are useful in coating compositions, such as aqueous-based paint and paper coatings. The voided polymer particles produced by the method of this invention impart improved gloss, brightness and opacity to paper coating formulations to which they are added. Also, the voided polymer particles produced by the method of this invention impart opacity to aqueous coating compositions, such as paints, to which they are added.

The following examples are presented to illustrate the process and the composition of the invention. These examples are intended to aid those skilled in the art in understanding the present invention. The present invention is, however, in no way limited thereby.

### EXAMPLE 1

### Preparation of Core Polymer Particles

A 5-liter, four necked round bottom flask was equipped with paddle stirrer, thermometer, nitrogen inlet, and reflux condenser. Deionized water, 1700 grams, was added to the flask and heated to 80° C. under a nitrogen atmosphere. A monomer emulsion (ME) was prepared by mixing 335 grams of deionized water, 14.0 grams of sodium dodecylbenzenesulfonate (SDS, 23%), 4.5 grams of methacrylic acid, and 364.5 grams of methyl methacrylate. From this ME, 82 grams were removed and set aside. To the remaining ME was added 7.0 grams of SDS (23%) and 241.0 grams of methacrylic acid. With the contents of the flask at 80° C., a mixture of 50 grams of deionized water and 9.8 grams of Plurafac™ B-25-5 surfactant (BASF Corporation), followed by the ME removed from the initial ME, followed by a mixture of 2.75 grams of sodium persulfate in 15 grams of deionized water were added to the flask. The contents of the flask was stirred for 15 minutes. The remaining ME was then fed to the flask over a two hour period while maintaining the contents of the flask at a temperature of 80° C. After the completion of the monomer feed, the resulting dispersion was maintained at 80° C. for 15 minutes, cooled to 25° C. and filtered to remove any coagulum. The filtered dispersion had a pH of 3.0, 21.9 weight % solids content, and an average particle diameter of 220 nm. The dispersion of Example 1 was an aqueous dispersion of core stage polymer particles.

### Comparative A—Preparation of Aqueous Dispersion of Voided Polymer Particles by Process Employing One Vessel

A 5-liter, four necked round bottom flask was equipped with paddle stirrer, thermometer, nitrogen inlet, and reflux condenser. Deionized water, 2405 grams, was added to the flask and heated to 86° C. under a nitrogen atmosphere. To the heated flask water was added 5.4 grams of sodium persulfate dissolved in 42 grams of deionized water. This was immediately followed by 387.7 grams of the aqueous dispersion of core polymer particles prepared in Example 1. A monomer emulsion (ME I) was prepared by mixing 70.73 grams of deionized water, 4.25 grams of SDS, 15.29 grams of butyl methacrylate, 151.13 grams of methyl methacrylate, and 3.39 grams of methacrylic acid, and was added to the flask at a rate of 6 grams/minute while maintaining the contents of the flask at a temperature of 80°. Upon the complete addition of ME I, a second monomer emulsion (ME II) was prepared by mixing 268.8 grams of deionized water, 5.38 grams of SDS, and 1018.9 grams of styrene. From ME II, 129.35 grams were removed and set aside. The initial portion of ME II was added to the flask at a rate of 25 grams/minute and a mixture of 2.68 grams of sodium persulfate dissolved in 105 grams of deionized water was co-fed to the flask at a rate of 3.5 grams/minute. The temperature of the contents of the flask was allowed to increase to 92° C. Upon completion of the ME II and co-feeds, a mixture of 11.3 grams of 4-hydroxy TEMPO (4-hydroxy-2,2,6,6-tetramethyl-1-piperidinyloxy free radical) and 11.3 grams of deionized water was added to the flask and the contents of the flask was cooled to 85° C. The contents of the flask, which contained the multi-stage polymer particles, were at 26.2 weight % solids. When the flask temperature reached 85° C., the held back portion of ME II (129.35 grams) was added to the flask followed by the addition of 59 grams of ammonium hydroxide. The contents of the flask was maintained at 85° C. for five minutes. Next, a mixture of 1.34 grams of sodium persulfate dissolved in 30 grams of deionized water was added to the flask. The contents of the flask was maintained for 30 minutes at 85° C. and then cooled to room temperature and filtered to remove any coagulum. The aqueous dispersion of voided polymer particles had a solids content of 26.6 weight %, a pH of 10.3, and a particle diameter of 650 nm. An acid titration showed good core encapsulation with only 5.4% core acid titratable. The dry density of this polymer was measured to be 0.6061 g/cc. The process of Comparative A produced 4600 g of aqueous dispersion containing the voided polymer particles.

### EXAMPLE 2

### Preparation of Aqueous Dispersion of Voided Polymer Particles by Process Employing Two Vessels

A 5-liter, four necked round bottom flask is equipped with paddle stirrer, thermometer, nitrogen inlet, and reflux condenser. Deionized water, 2000 grams, is added to the flask and heated to 86° C. under a nitrogen atmosphere. To the heated flask water is added 7.7 grams of sodium persulfate dissolved in 61 grams of deionized water. This is immediately followed by 554.84 grams of the aqueous dispersion of core polymer particles prepared in Example 1. A monomer emulsion (ME I) is prepared by mixing 101.3 grams of deionized water, 6.08 grams of SDS, 21.88 grams of butyl methacrylate, 216.4 grams of methyl methacrylate, and 4.86 grams of methacrylic acid and is added to the flask at a rate of 6 grams/minute while maintaining the contents of the flask at a temperature of 80° C. Upon the complete addition of ME I, a second monomer emulsion (ME II) is prepared by mixing 385 grams of deionized water, 7.7 grams of SDS, and 1459 grams of styrene. From ME II, 185 grams are removed and set aside. The initial portion of ME II is added to the flask at a rate of 25 grams/minute and a mixture of 2.68 grams of sodium persulfate dissolved in 105 grams of deionized water is co-fed to the flask at a rate of 3.5 grams/minute. The temperature of the contents of the flask is allowed to increase to 92° C. Upon completion of the ME II and co-feeds, a mixture of 11.3 grams of 4-hydroxy TEMPO (4-hydroxy-2,2,6,6-tetramethyl-1-piperidinyloxy free radical) and 11.3 grams of deionized water is added to the flask. The contents of the flask, which contain the multi-stage polymer particles, are at 34.4 weight % solids. The contents of the flask are transferred to a second vessel (7-liter vessel fitted with an overhead stirrer) and cooled to 85° C. Heated dilution water, 2190 grams at 85° C., is added to the second vessel with stirring, followed by the addition of the withheld monomer emulsion (185 grams) from above. Ammonium hydroxide (85 grams) is added to the second vessel and the contents of the second vessel is maintained at a temperature of 85° C. for 5 minutes. After the 5 minute hold, a mixture of 1.9 grams of sodium persulfate dissolved in 40 grams of deionized water is added to the second vessel. The contents of the second vessel is maintained at a temperature of 85° C. for 30 minutes and then is cooled to room temperature and filtered to remove any coagulum. The aqueous dispersion of voided polymer particles, which is prepared by the process of this invention, has a solids content of 26.6 weight % and the physical properties, the particle diameter, the pH, and the dry density are similar to the comparative sample prepared in Comparative A. The process of Example 2, produces 6917 grams of the aqueous dispersion of voided polymer particles.

The process of Example 2 provides a 50% increase in product yield compared to the comparative process of Comparative A (6917 grams versus 4600 grams, respectively).

1. A process for preparing an aqueous dispersion of voided polymer particles, comprising the steps of:
a) preparing an aqueous dispersion of multistage polymer particles in a first vessel; wherein said multistage polymer particles comprise:
i) a core stage polymer comprising as polymerized units, based on weight of said core stage polymer: from 5 to 100 weight % hydrophilic monoethylenically unsaturated monomer, and from 0 to 95 weight % of at least one nonionic monoethylenically unsaturated monomer;
ii) a shell stage polymer comprising as polymerized units, based on weight of said multistage polymer particles, at least 50 weight % of at least one nonionic monoethylenically unsaturated monomer;
b) providing monomer at a level of at least 0.5 weight % based on weight of said multistage polymer particles under conditions wherein there is no substantial polymerization of said monomer;
c) swelling said multistage polymer particles in a second vessel; and then
d) reducing said level of said monomer by at least 50 weight % of said monomer, to provide said aqueous dispersion of voided polymer particles.

2. The process according to claim 1 wherein said second vessel has a volume that is at least 1.2 greater than volume of said first vessel.

3. The process according to claim 1 further comprising a step of adding water to the second vessel prior to swelling said multistage polymer particles.

4. The process according to claim 1 wherein said monomer is added to said first vessel.

5. The process according to claim 1 wherein said monomer is added to said second vessel.

6. The process according to claim 1 wherein said first vessel is a reactor and said second vessel is a drain tank.

7. The process according to claim 1 wherein said aqueous dispersion of multi-stage polymer particles has a solids level of at least 30 weight %, based on the weight of said aqueous dispersion of multi-stage polymer particles.

8. The process according to claim 1 Wherein further comprising the step of employing an effect amount of one or more polymerization inhibitors or reducing agents to obtain said conditions wherein there is no substantial polymerization of said monomer.

9. An aqueous dispersion comprising voided polymer particles; wherein said aqueous dispersion is prepared according to a process comprising the steps of:
a) preparing an aqueous dispersion of multistage polymer particles in a first vessel; wherein said multistage polymer particles comprise:
i) a core stage polymer comprising as polymerized units, based on weight of said core stage polymer: from 5 to 100 weight % hydrophilic monoethylenically unsaturated monomer, and from 0 to 95 weight % of at least one nonionic monoethylenically unsaturated monomer;
ii) a shell stage polymer comprising as polymerized units, based on weight of said multistage polymer particles, at least 50 weight % of at least one nonionic monoethylenically unsaturated monomer;
b) providing monomer at a level of at least 0.5 weight % based on weight of said multistage polymer particles under conditions wherein there is no substantial polymerization of said monomer;
c) swelling said multistage polymer particles in a second vessel; and then
d) reducing said level of said monomer by at least 50 weight % of said monomer, to provide said aqueous dispersion of voided polymer particles.
